(19) United States
(12) Patent Application Publication
(10) Pub. No.: US 2016/0061938 A1
(43) Pub. Date: Mar. 3, 2016

(54) Clutter Rejection Using Spatial Diversity In Wideband Radar For Enhanced Object Detection

(71) Applicant: Flex Force Enterprises LLC, (US)

(72) Inventors: Daniel J. Hyman, Long Beach, CA (US); Jacob Ryan Sullivan, Portland, OR (US)

(73) Assignee: FLEX FORCE ENTERPRISES LLC, Portland, OR (US)

(21) Appl. No.: 13/717,557

(22) Filed: Dec. 17, 2012

Related U.S. Application Data
(60) Provisional application No. 61/657,207, filed on Jun. 8, 2012.

(51) Int. Cl. G01S 7/41; G01S 13/02

(52) U.S. Cl. CPC G01S 7/414; G01S 13/0209

(57) ABSTRACT

Techniques are described that enable wideband radar systems with fast signal processing to detect certain types of targets in crowded and cluttered areas that challenge conventional radar architectures and signal processing methods. Multiple data sets are collected from at least one receiver within a radar system. Various weighting parameters are applied to the data sets to reduce the effect of clutter objects. Related systems, apparatus, methods, and articles are also described.

### CROSS REFERENCE TO RELATED APPLICATION

The present application claims priority under 35 U.S.C. §119 to U.S. Provisional Application Ser. No. 61/657,207, filed Jun. 8, 2012, entitled CLUTTER REJECTION USING SPATIAL DIVERSITY IN WIDEBAND RADAR FOR ENHANCED OBJECT DETECTION, the disclosure of which is incorporated herein by reference.

### FIELD

The subject matter described herein relates to the detection of targets with small signatures in volumes containing large amounts of clutter. For example, the current subject matter can be use for the detection of enemies aiming firearms at or near the user from positions of concealment in dense urban or rural terrain.

### BACKGROUND

Military, paramilitary, and criminal activities have long recognized the value of operations and attacks from positions of cover and concealment. The use of snipers, ambushes, sneak attacks, and guerrilla tactics has increased in recent years, with a transition to combat and criminal activities in and around areas with populations of uninvolved civilians and non-combatants. In response, military and law enforcement leaders have emphasized the use of sensor systems and increased situational awareness to increase operational effectiveness while simultaneously reducing civilian casualties and collateral damage.

Detection, classification, and location of threats are critical to the success of any military operation. Before the advent of modern warfare, military leaders had little access to real-time situational awareness beyond scouts and telescopes, and the individual warfighter had no access at all. With the advent of modern warfare came the application of sensor technologies, including real-time tactical threat detection and location at the squad level. Several electro-optical and acoustic systems have been developed to help triangulate the location of a sniper once they fire; Project Overwatch uses thermal imagers, and Boomerang and ShotSpotter use acoustic echolocation to identify the direction and distance of snipers once they fire. These systems enable friendly forces to protect themselves from the direction of the shooter, and more quickly identify the shooter location and mount a counterattack. Unfortunately, the initial damage done by the shooter is unchanged by these systems. An officer, specialist, or materiel will already have been fired upon before any of these systems can provide any information about the danger.

Despite the efforts of numerous developers, no optical or acoustic technology enables concealed enemy combatants using iron sights (i.e., nearly every weapon used today) to be detected and identified before they shoot. Other detection sensors identify the presence of people and weapons, but have difficulty detecting intent to harm. Reaction sensors identify the location and direction from which an attack was launched, but they provide little value or comfort to a victim already wounded or killed by the first shot. Instead, when facing insurgents, snipers, terrorists, and violent criminals, forces desperately need a sensor technology that can detect the presence and location of a shooter that is poised to strike (or strike again) from a position of cover and concealment. This system must be able to identify such enemy combatants by rejecting the presence of cluttering objects (e.g., walls, windows, rocks, and foliage) in real time so that the user can be alerted in a timely manner in order to initiate defensive measures and counterattack.

In the separate operational environment of maritime radar, a similar radar clutter problem arises with respect to locating small vessels, persons, and objects in water under conditions of wind and waves. Water is an excellent electromagnetic wave reflector across a wide frequency range, and when shaped into waves in deep water or coastal surf, conditions of highly reflective moving clutter effectively obscures targets with present maritime radar systems. Even optical systems can be challenged in high waves, as complete obscuration of small vessels or personnel can occur in normal conditions. Line-of-sight illumination capability can easily drop below 20%, with radar target location confounded by the high broadband reflectivity and changing shape of waves. What is needed is a system architecture and signal processing method that can effectively suppress the clutter reflections provided by high moving waves so that targets of critical interest can be resolved.

In the field of radar systems, the typical clutter rejection problem is characterized by a target that is often small and fast-moving relative to a nearby volume of large and slow-moving clutter. Contemporary methods used in the radar field to reject clutter concentrate on the narrow-band characterization, and eliminating it through limited characterization of the nature of the clutter. In many cases, such as tracking objects in the air or space, there is little to no clutter, and other sources of undesirable signals (e.g., noise, electromagnetic warfare, etc.) must be suppressed in order to properly identify and characterize the target of interest.

Signal backscatter from cluttering objects often varies greatly with facing due to the reflection of different materials and structures in different directions. Urban cluttering objects in particular see a dramatic change in response with frequency and angles of incidence and reflection, as even rough walls reflect some radar frequencies in a predictable manner. Large waves also present significant and fast-changing reflection characteristics across broad frequency ranges. If cluttering objects also move in time and space in a moderate manner (i.e., wind-blown vegetation or chattel, walking persons, etc.) then these provide additional variations in space and time that differentiate clutter from moving and stationary targets of interest.

Across a broad frequency range, the spatial variance of many cluttering objects will usually be very different. A fir tree, for example, will have significant reflection at certain frequencies due to a commonly occurring length of needles in a particular species of a particular range of tree age. In light wind, for example, reflected signals at these frequencies will vary wildly, whereas other frequencies will show little variance. Similar findings have been found over decades of studying different crop fields, rocky minerals, metal building hardware, brick and concrete walls, etc. for different frequencies and angles of reflection.

In comparison, a target object such as a large metal sphere or corner reflector does not vary greatly with comparatively wide ranges of signal frequency, and does not vary greatly with wide ranges of facing (or not at all for a perfect sphere). There are many objects of interest in the fields of radar systems and force protection that similarly do not vary in reflected signal response with small to moderate changes in angle, position, or time. Other types of objects of interest, such as dipole antennas, may vary in angle, position, or time, but they do so in very predictable ways, which provides a means of differentiation with respect to common cluttering objects.

In the example of a sensor that needs to spot a concealed enemy combatant aiming a weapon, the weapon provides a relatively constant signal due to the signature and radiating characteristics of the barrel, whereas the clutter around the enemy combatant changes. Reflected signals change due to position of the sensor system, angle of incidence and reflection to the clutter around the combatant (e.g., wall reflections), and wind (affecting foliage reflections), and the amount and nature of these changes vary considerably by frequency for different objects.

### SUMMARY

In one aspect, a method of enhanced object detection includes processing multiple received radar signals that have been reflected from a volume of interest. The multiple signals will have been transmitted and received from different locations in space, and provide different characteristics at different frequencies for each received signal. A weighting of the magnitude and phase values for each frequency is applied to each received signal. The weighted signals are added together, providing a single processed signal which is then assessed for the presence of a target. In this aspect, the reflections from cluttering objects vary between the multiple received signals in a substantially differing manner than the reflections from the target of interest, enabling the combined effect of the reflections of said clutter to be suppressed as compared to the combination of received signals reflected from the target.

In additional interrelated aspects, a method of enhanced object detection includes multiple radar signals that are either transmitted or received from different locations during a single instance of transmit and receive ranging, which would necessarily require at least two antennas for the radar system. If the radar platform is moving, then time can be used to provide spatial variance that may augment engineered spatial variance.

In other interrelated aspects, weighting factors are dynamically assigned based on sensor and operational states, and/or recently processed data sets. Weighting factors used for individual data points for specific frequencies may include zero (i.e., eliminating a data point in magnitude) or other real or imaginary number. These weighting factors may be assigned based on pre-determined or dynamically assigned values prior to or throughout operation depending on how and where the system is used, or on what type of targets and clutter are expected. In these aspects, individual data points can be weighted and integrated for each data point separately for real and imaginary values rather than magnitude and phase values.

In a separate interrelated aspect, a method of enhanced object detection includes transmitting multiple radar signals towards a potential firearm barrel, receiving multiple reflected radar signals that have been reflected from the potential firearm barrel, and employing signal processing to the received signals to suppress cluttering objects and determine if a firearm barrel is pointed at or near an object of interest. If so, a threatening firearm barrel object has been detected, and an alert is provided to the user.

In a system-based interrelated aspect, a method of enhanced object detection would be incorporated into a sensor system, including an outbound antenna apparatus that transmits an outbound radio frequency signal toward a potential target of interest and an inbound antenna that receives an inbound reflected radio frequency signal from the potential target as well as from surrounding cluttering objects. A signal processing algorithm analyzes multiple received radar signals over time to determine whether a target is presented to one or more receiving antennas.

In a further interrelated aspect, radio frequency signals are transmitted towards a zone of interest containing a plurality of targets from a first location and radio frequency signals reflected from the zone of interest are received. The received radio frequency signals are compared to a library of radio frequency signatures and patterns for a plurality of different targets to identify targets in the zone of interest. It is then determined using the received radio frequency signals whether the identified targets in the zone of interest are positioned in a manner that represents a threat towards the first location or towards a different location. Data characterizing at least one target in the zone of interest can then be provided.

In some variations one or more of the following can optionally be included. The processed signal can optionally be compared to a library of one or more pre-characterized targets to identify whether or not a particular target is detected. The processed signal can optionally be compared to a set of known characteristics of one or more pre-characterized targets to identify whether or not a type of target is detected. The processed signal can optionally be compared to a set of known characteristics of one or more pre-characterized clutter objects to assist in rejecting the signals reflected from that type of cluttering object, or to dynamically adjust weighting factors for specific frequencies of data points from received signals. The transmitted signal can optionally be adjusted based on known characteristics of one or more pre-characterized clutter objects in order to provide for received signals that can be more readily weighted and processed for the purpose of clutter rejection.

Computer program products are also described that comprise non-transitory computer readable media storing instructions, which when executed one or more data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein can provide, among other possible advantages and beneficial features, systems, methods, techniques, apparatuses, and article of manufacture for detecting a threatening firearm that is aimed at or near a radar system configured to resolve the specific characteristics of that firearm. Implementations of this subject matter could provide critical advance warning of sniper attacks on tactical warfighters and supply convoys before they occur, which would save lives and materiel. Improved clutter rejection can improve the resolution of radar signatures that can be compared against specific characteristics of weapons commonly employed in the area.

The subject matter described herein can also provide, among other possible advantages and beneficial features, systems, methods, techniques, apparatuses, and article of manufacture for detecting vessels, objects, and people in severe marine environments. Typical weather in deep water can cause waves that exceed the height of people, buoys, and many vessels. Implementations of this subject matter could provide critical advance warning of small enemy surface or partially submerged vessels, vessels damaged by (or a “man overboard” imperiled by) rough weather, or objects of critical interest to military, law enforcement, rescue, or coastal border control operations. Improved clutter rejection can improve the resolution of radar signatures of vessels, people, and other targets of interest, and save lives and materiel.

The details of one or more variations of the subject matter described herein are set forth in the accompanying drawings and the description below. Other features and advantages of the subject matter described herein will be apparent from the description, drawings, and claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed embodiments. In the drawings,

FIG. 1 is a schematic illustration of radar transmit and receive antennas directed at four different types of targets in a cluttered radio environment, together with a transmit signal, reflected signals, and a combined received signal;

FIG. 2 is a schematic illustration of radar transmit and receive antennas a short distance away from the position illustrated in FIG. 1, together with a transmit signal, different reflected signals, and a different combined received signal;

FIG. 3 is a schematic illustration of radar transmit and receive antennas a further distance away from the positions illustrated in FIGS. 1 and 2, together with a transmit signal, different reflected signals, and a different combined received signal;

FIG. 4A is a schematic illustration of the reflected signal from one example target object, showing distinctive characteristics of the signal of interest.

FIG. 4B is a schematic illustration of the reflected signal from one cluttering object taken from three different positions, showing varying signal characteristics.

FIG. 4C is a schematic illustration of a combined received signal including target reflections and multiple cluttering object reflections without effective clutter rejection;

FIG. 4D is a schematic illustration of the lowest received signal strength for the target superimposed with the lowest received signal strength for each frequency point for the three cluttering object positions;

FIG. 4E is a schematic illustration of the combined signal after signal processing to resolve the distinctive characteristics of the target.

FIG. 5 is a schematic illustration of a radar antenna system having one transmit antenna and three spatially diverse receive antennas.

FIG. 6 is a schematic illustration of a radar antenna system having three spatially diverse transmit antennas and one receive antenna.

FIG. 7 is a schematic illustration of a radar antenna system with one transmit antenna and two spatially diverse receive antennas transmitting and receiving signals from four different types of moving and non-moving objects, including the open mouth of a firearm barrel treated as a short-circuited circular waveguide as a target object of interest.

FIG. 8 is a schematic illustration of the system of FIG. 7 after a short time delay, showing the firearm barrel has not moved, but the cluttering objects have moved, providing differentiation in the signals received and enabling clutter rejection.

### DETAILED DESCRIPTION

The subject matter described herein can provide new signal processing and sensing techniques for improved situational awareness, threat detection, and force protection. Counter-sniper and counter insurgency missions and operations of all types can be improved by employing the subject matter. Maritime applications of sensing vessels, objects, and people in rough weather conditions can be improved due to the difficulty of wave clutter rejection for presently deployed systems. Law enforcement and domestic security operations across a range of sensor applications can be similarly improved. Additional benefit can be gained by combining with other passive and active sensor technologies, and by deploying sensor-trained personnel in high-risk applications and missions.

Present radar signal processing methods are inappropriate for suppressing spatially or time-varying clutter with changing radar backscatter characteristics when searching for targets with unchanging or predictable radar backscatter characteristics. Fortunately for the radar industry, these types of scenarios have had limited customer interest, so there has been little impetus to develop such signal processing techniques and system architectures. When such situations arise in the radar industry, however, existing systems can provide only diversity in time, and falter in suppressing rapidly moving clutter at or near targets of interest if the clutter has similar (or larger) reflections in the limited frequency bands used for interrogation.

Existing limitations of conventional signal processing methods can be overcome by deploying systems designed to gather spatial and/or temporal diversity data, then employing the present subject matter to process this data for the purpose of clutter rejection and enhanced detection and identification. For specific types of targets located in many types of clutter, this will provide significant improvement in clutter rejection. For most radar applications, however, the present subject matter is not expected to provide improvement, and may instead make detection less successful. Because this subject matter suppresses clutter in a different manner than that required by most applications, engineering discipline must be applied judiciously when deciding to employ the present subject matter.

According to numerous government researchers and industry developers, a wideband radar system can be used to detect weapon barrels while they are aiming at or near its antenna. Such systems would provide tactical warfighters and operations personnel a critical location and identification advantage when facing enemy scouts, snipers, strongholds, or ambushes. Weapon barrels have a characteristic radar signature associated with their size and shape, and these signatures can be identified in a received radar signal. The re-radiating size of the cross-section of a typical firearm barrel might be only a fraction of a square centimeter, but the signal characteristics are reproducible and identifiable as a radar “fingerprint”, which does not vary significantly with small angle differences in aim direction or small lateral movement.

Although there are a number of different weapon types that have barrels or tubes as part of their physical structure (including but not limited to cannons, firearms, mortars, and rocket tubes), these are herein defined by the general term “firearms” in the context of the present subject matter. These weapons, insofar as they are aimed at or near a radar system antenna, are herein referred to as “firearm threats.” Firearm threats are distinguished from detectable weapons that are not aimed at or near the radar system antenna, which are referred to herein as non-threatening firearms. Furthermore, in this subject matter, a weapon barrel is defined as the entire electromagnetically projective cavity for a weapon, which may include the physical weapon barrel itself, as well as the chamber, and a round or other ammunition which may or may not be chambered or otherwise ready for firing.

The clutter problem in this example application is challenging, as firearm attacks typically occur from positions of considerable concealment and cover, with urban and rural types of cluttering objects commonly in the immediate vicinity of the muzzle end of the firearm. The backscatter signal from cluttering objects can be several orders of magnitude higher than the signal from the weapon barrel, and changes rapidly with angle of incidence and reflection, movement of the radar platform, or movement of the objects themselves (e.g., due to wind, waves, etc.).

As a radar system interrogates a volume of space containing a firearm threat and a multitude of cluttering objects, the re-radiated signal from the weapon barrel does not change significantly, but the backscatter from surrounding cluttering objects will vary across some (or even all) of the frequencies used in the transmitted radar signal. Conventional radar signal processing techniques are ill-suited to address this type of target and clutter scenario.

According to various implementations of the currently disclosed subject matter, a system architecture and signal processing method can provide spatial and/or temporal diversity. This diversity allows for multiple sets of data to be collected by one or more receivers, each data set comprising a collection of values for phase and amplitude (alternatively and equivalently, real and imaginary values instead) for a defined set of frequencies. These data sets can then be weighted in different manners according to their location, time, nature of target, nature of clutter, or other operational characteristics, and then combined through addition, integration, or other mathematical comparison or combination methods. When weighted and combined across multiple data sets, the electromagnetic presence of varying clutter can be reduced while the electromagnetic presence of non-varying or low-varying targets will not be reduced.

There are a number of general concepts in radar sensors, whereby these sensors aid in the detection, location, and alerting to the presence of enemy forces, weapon threats, vessels of interest, endangered personnel, and other objects of critical interest. The following description first discusses the fundamentals of the clutter problem with respect to ranges, powers, and other characteristics of radar systems in these applications. The description then follows with a functional means by which an object can be detected by employing radar systems through use of figures and descriptions of these figures. It then continues and finishes with details of a specific implementation of this subject matter.

One fundamental aspect of radar sensor design is target detection range. Range examples are important to aid designers in developing a system with a relevant and feasible set of operating capabilities. In the radar range equation, increasing range of the target reduces the power level of the received signal to the fourth power, which therefore increases the power required by the system or equivalently increases the required sensitivity of receive electronics and signal processing capabilities.

An RF signal travels in air at nearly the speed of light (c˜3×10⁸ m/s), so a radar system employing these methods out to a range of thousands of meters only has tens of microseconds of delay between when a signal is transmitted and when the primary reflected signals are returned. One microsecond would be enough time to permit a primary reflection from a target about 150 meters away, which is a long enough range to encompass the majority of firearm attacks. One hundred microseconds would be enough time to permit a primary reflection from a target 15 kilometers away, which is long enough range to encompass the majority of maritime detection needs.

Distance for assessing targets in cluttered environments are often “range binned” as a standard practice in the radar industry. In range binning, time segments are created for each data set encompassing everything in a single field of view between two distances as a single increment or “range bin.” The radar receiver then processes the sum of the data that is received from the objects that are reflected from the time period associated with each range bin, essentially digitizing and segmenting the many received signals into discrete range increments out to the maximum detection range. A range bin for a firearm threat radar system might, for example, vary between 0.1 m for a highly sensitive system with a wide instantaneous receiver bandwidth and 20 m for a low sensitivity system, such as might be used on a personal radar system that consumes much less power. A range bin for a maritime system might, for example, vary between 0.1 m for a sensitive system used for detecting overboard personnel or small floating or subsurface objects and 50 m for a civilian small vessel ranging system.

The combination of range and range bin, along with the directivity of the antennas used and the viewing angle with respect to the dominant terrain in the field of view can be used to geometrically calculate a volume in real space. A different volume of space is associated with each range bin and field of view (antenna aim). The objects present in each of these range binned volumes provide the majority of the backscatter signals that are received and correlated with each range bin. The received signals are then analyzed to determine if any target object of interest can be detected, and if so, it is then correlated to the physical location of the ranged binned volume and reported to the user. A critical aspect of this arrangement is that the volume of each range bin determines how much potential clutter could be present to overwhelm the signal of a target of interest. The wider the antenna beam field of view, and the longer the range, the physically larger the volume is that could contain clutter to prevent object detection. The purpose of this subject matter is to increase the effective amount of volume of certain types of clutter in order to still resolve certain types of targets. This increase directly correlates to a longer detection range or wider field of view, and an associated increase in detection capabilities.

As an instructive example of range calculation, consider a radar system operating at 25 GHz with an antenna gain of 30 dB and a transmitter power of 500 W. It is desired to detect a signal from the end of a 7.62 mm rifle barrel with an electrical equivalent cross-section of only 46 mm², using a radar system receiver with a minimum detectable signal of −110 dB. Using the radar range equation for an uncluttered environment without pulse integration or signal processing, the maximum range of detection for this example is 120 m. Assuming a main beam angle of about 6.4° in both width and height, the volume of potential clutter at 120 m and 1 m range binning is about 135 cubic meters. The volume of actual clutter in will generally be a fraction of this volume, as some sky or skyline is present under most conditions, but this is still a significant volume considering the object of interest is very small.

As a separate instructive example of range calculation, consider a radar system operating at 10 GHz with an antenna gain of 45 dB and a transmitter power of 5 kW. It is desired to detect a signal from a small boat with an electrical equivalent cross-section of 3 m² using a receiver with a minimum detectable signal of −110 dB. Using the radar range equation for an uncluttered environment without pulse integration or signal processing, the maximum range of detection for this example is 12 km. Assuming a main beam angle of about 1.2° in both width and height, the volume of potential clutter at 12 km with 5 m range binning is 430,000 cubic meters. In severe conditions, it is possible that up to 5% of this volume could contribute cluttering waves, resulting in many orders of magnitude more clutter than target. It is clear to anyone skilled in the art that the clutter effects from high wave conditions will limit the range of effective target resolution, as opposed to radar range propagation loss and receiver limits of many kilometers.

Enhanced object detection methods according to some implementations of the current subject matter could be used in radar systems transmitting low to moderate RF powers (for example, between 1 W and 1 kW) using high gain antennas (in some examples, at least 20 dBi) and with an effective maximum operable range of between approximately 20 m and 500 m in a cluttered RF environments. This effective and operable range might be considerably longer in a less cluttered area such as a rural area or with calmer seas, or in an area dominated by foliage rather than metallic, water, and mineral features. Such radar system characteristics could be readily applied to portable and/or small vehicle-mounted sensor systems. It is further recognized that applications demanding opposing requirements of lower powers and longer operable range in a system employing these methods may require higher levels of radar receiver sensitivity, different pulse shaping techniques, and/or more advanced receiver hardware and signal processing techniques than those suggested herein. Use of enhanced object detection methods according to some implementations of the current subject matter in radar systems transmitting high RF powers (10 kW or more) using very high gain antennas (45 dBi or more) may have an effective operable range of several km even under adverse conditions.

Throughout this description, possible physical and electrical characteristics for elements of a system employing methods according to the subject matter described herein have been suggested. An illustrative example of the current subject matter includes discussion of detection of AK-47 firearms and its many variants, which represent a category of threats encountered worldwide. However, it will be readily understood from the following description and figures that a wide range of other targets can be detected in threat detection, maritime, and other applications in a similar manner by modifying various system architectures, settings, signal processing techniques, inputs, and/or algorithms.

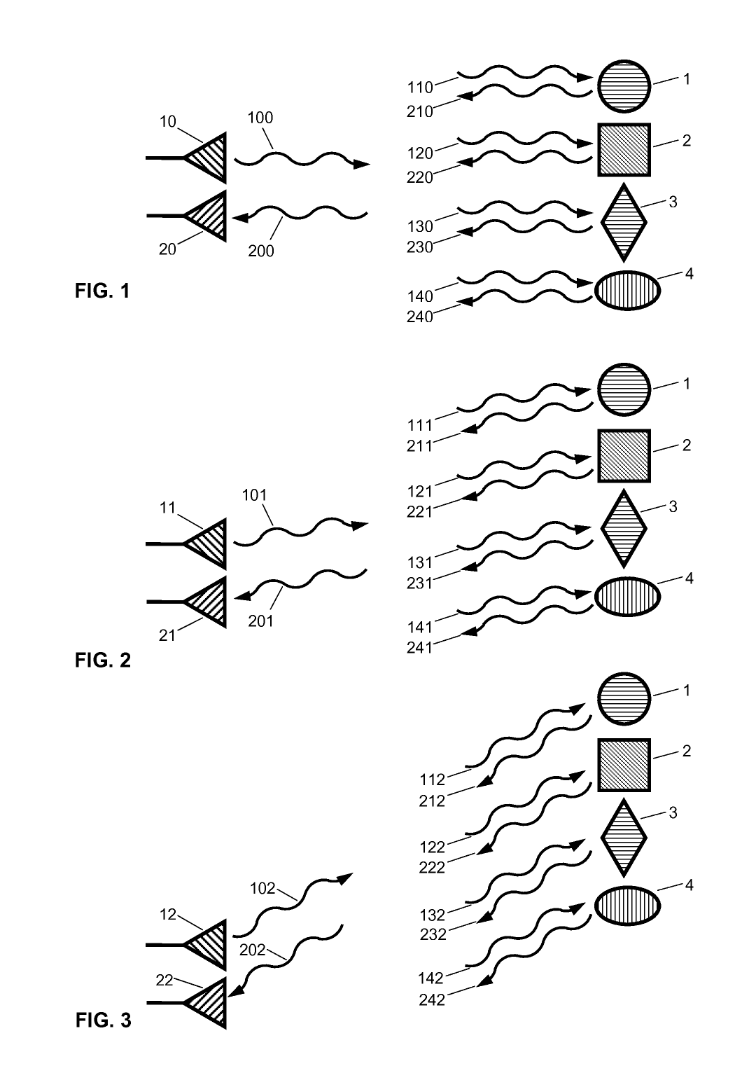

A system employing one or more implementations of the current subject matter can include elements for directing the antenna and signal, for detecting reflected signals, and for processing the detected signals to resolve the presence of objects of interest. While reference is made to microwave radar systems, other bands of radio frequency signals can also be utilized. FIG. 1 is a schematic illustration of a radar transmit antenna 10 transmitting a highly directed first transmitted signal 100 towards a target object 1, normal clutter 2, angled clutter 3, and similar clutter 4, all representing types of objects that might be found in an operational environment. As suggested in FIG. 1, the radar transmit antenna 10 enables the transmission of RF energy in a highly directed manner, as the radar receive antenna 20 similarly enables the reception of RF energy in a highly directed manner. Each of the radar antennas further attach to the rest of the radar transmit and receive electronics (not shown).

In a well-designed, highly-directed radar antenna, the primary antenna beam shape will have a high level of gain, defined as being greater than ten, and all of the sidelobes will have a comparatively low level of gain, defined as being less than 5% of the gain of the primary antenna beam. It is expected that multiple polarizations of incoming radar signals (e.g., horizontal and vertical polarizations, or clockwise and counter-clockwise polarizations) would each be received by a well-designed antenna with a high level of directivity and gain, and have low sidelobes as defined above. A wide variety of antennas are used throughout the radar field, however, so these typical examples are not meant to be restrictive to the values and characteristics explicitly stated.

In FIG. 1, the radar antennas 10 and 20 are directed at a collection of objects, which includes the target object 1 of greatest interest. The target object 1 is illustrated as a metallic sphere which has a radio frequency reflectivity that is identical/substantially identical in all directions for many frequencies of interest as limited by its size, spherical perfection, surface roughness, and other characteristics. These characteristics are important for the present subject matter, as the direction of the incoming target object signal 110 will not affect the characteristics of the reflected target object signal 210 other than the direction of return.

The collection of objects additionally includes other objects that represent cluttering objects that provide reflected signals that are obscuring the desired reflected target object signal 210. Normal clutter 2 represents a cluttering object that provides a high magnitude of broadband reflection of the incoming normal clutter signal 120 when approached from a face-normal direction such as is illustrated in FIG. 1. The reflected normal clutter signal 220 could represent the signal seen from reflections off a cinderblock wall or metal door frame facing the radar antennas, and in this example would be a significant clutter signal that will need to be suppressed in order to resolve the reflected target object signal 210.

A second item of clutter in the collection of objects is angled clutter 3, which represents an object of clutter that might be reflecting strongly in certain directions, but not in the normal incident direction perpendicular to the radar antennas 10 and 20. The incoming angled clutter signal 130 illuminates the angled clutter 3, but the reflected angled clutter signal 230 is not particularly strong. The reflected angled clutter signal 230 caused by this particular position is unlikely to prevent the resolving of the reflected target object signal 210. An example of such a cluttering object may include a brick wall facing that is at a 30 degree angle from the radar antennas. The relatively smooth brick surface would reflect most of the radar signal away at a negative 30 degree angle, and very little signal would be reflected back towards the antennas.

The collection of objects further includes similar clutter 4, which represents objects that may appear to be very similar to the target object 1 when viewed from certain angles or using specific polarizations, frequencies, waveforms, or ranges. In this case, the incoming similar clutter signal 140 illuminates the similar clutter 4, which then creates the reflected similar clutter signal 240. In the case of FIG. 1, it may be considered that the reflected similar clutter signal 240 has many similar characteristics to the reflected target object signal 210, and may therefore be a potential source of “false positives”. The radar system may have difficulty resolving the difference between a target object 1 and a similar object 4. In this example, an oval shape is illustrated, as an oval or ovoid solid is very similar to a circle or sphere under many forms of radar illumination. A maritime equivalent might be a buoy cluttering object for a system that is attempting to locate personnel overboard.

All of the four reflected signals from the objects travel back to the receive antenna 20, and decay in signal strength in accordance with electromagnetic propagation phenomena, including but not limited to transmission losses, ground reflection, and other effects. In this example, the reflected signals propagate and are combined into a first received signal 200. It is recognized that, in reality, many other elements of data will also be incorporated into the received signal, such as thermal noise, multiple reflections from other objects, including but not limited to the ground, multipath signals, etc., but these are all ignored for the purposes of discussion of the present subject matter.

The transmit antenna 10 and receive antenna 20 may be manufactured of a wide variety of metallic, semiconductor, and/or dielectric materials using a wide variety of architectures and designs in accordance with the state of the art in radar antenna design and manufacturing technologies. The target object 1 and similar object 4 might be manufactured, grown, or assembled out of materials including metals, plastics, woods, or organic materials. The target object might be a firearm barrel, a mortar tube, a fishing boat, an overboard crewman, or any other type of target of interest, so similar objects might be any number of objects that appear electromagnetically similar. The normal clutter 2 and angled clutter 3 can encompass a wide range of objects that could potentially be manufactured of almost any material, with particular interest given to those objects manufactured of steel and other metals, mineral-heavy materials such as rock, brick, or clay, water-rich organic materials such as many types of foliage, and for seawater waves for maritime systems. These materials are most likely to provide the types of radar reflections of interest to this subject matter, in that they must be suppressed to resolve a target object 1.

The size ranges of radar antennas 10 and 20 used with the current subject matter can in some implementations be in the range of approximately 10 cm² to 1000 m². This range can include sizes that are appropriate for man-portable, vehicle-mounted, and fixed asset platforms. The directivity of the primary antenna beam can in some implementations be in a range of approximately 10 and 1,000,000, which covers the range of typical radar antennas used across these platforms according to the state of the art.

In the application of a firearm threat detection system, the target object 1 is typically a weapon barrel. The barrel diameters of a threatening firearm, non-threatening firearm, and similar clutter object may optionally be in the range of approximately 2 mm and 250 mm, which covers the range of typical firearms and other vehicular threats of relevant interest including but not limited to cannons, mortars, rockets, and rocket-propelled grenades. The sizes of other clutter objects can be any size and shape, as might be expected in the widely varying environments of urban, suburban, and rural engagements.

In the application of a maritime radar system, the target object 1 is typically a small boat or person. The dimensions of small boats and similar clutter objects may optionally be in the range of approximately 1 m to 50 m, which covers the range of typical small to medium sized water vessels of relevant interest including but not limited to rowboats, lifeboats, sailboats, motorboats, yachts, fishing boats, tugboats, patrol boats, and most pleasure craft. The sizes of other clutter objects can be any size and typically in the variety of liquid wave shapes, which have many smooth and rough surfaces that can be very fast moving and changing in size and shape, as might be expected in severe weather or deepwater operations.

FIG. 2 illustrates a second position for the radar antennas, showing a shifted transmit antenna 11 and a shifted receive antenna 21 that are in a different relative position with respect to the target object 1, normal clutter 2, angled clutter 3, and similar clutter 4. In this new position, the shifted transmit antenna 11 transmits a second transmitted signal 101 towards the objects. This transmitted signal propagates towards the objects, illuminating the target object 1 with a second incoming target object signal 111 resulting in the second reflected target object signal 211. Because of the characteristics of a metallic sphere and the waveform selected for an example radar system, the second reflected target object signal 211 is nearly identical in characteristics to the original reflected target object signal 210, except for the directionality of the reflection.

The transmitted signal also illuminates the normal clutter 2 with an incoming second normal clutter signal 121, resulting in the second reflected normal clutter signal 221. In this new position, the angle of incidence on the normal clutter 2 is increasing from 90 degrees, and therefore the second reflected normal clutter signal 221 is reduced in magnitude and may have other characteristics that are substantially different from the original reflected normal clutter signal 220. The reflections due to this cluttering object may still be substantial, but they are not as severe as in the first position, and therefore represent a reduced challenge to the radar system to attempt to resolve the target object 1.

In a similar fashion, the transmitted signal also illuminates the angled clutter 3 with an incoming second angled clutter signal 131, resulting in the second reflected angled clutter signal 231. In this new position, the angle of incidence on the angled clutter 3 is also increasing from 90 degrees, but in this case, the second reflected angled clutter signal 231 is increasing in magnitude, and may have other characteristics as well that are substantially different from the original reflected angled clutter signal 230. The reflections due to this cluttering object are therefore representing an increasing challenge to the radar system to attempt to resolve the target object 1.

As with the other clutter objects, the transmitted signal further illuminates the similar clutter 4 with an incoming second similar clutter signal 141, resulting in the second reflected similar clutter signal 231. In this new position, the angle of incidence on the similar clutter 4 is also increasing from 90 degrees, but in this case, the second reflected similar clutter signal 241 is changing its characteristics to be slightly different from the original reflected similar clutter signal 230. The change in reflections due to this cluttering object are therefore representing a decreasing challenge to the radar system to properly reject similar clutter 4 as not being a target object 1.

All of the four reflected signals from the objects travel back to the shifted receive antenna 21, and decay in signal strength in accordance with electromagnetic propagation phenomena. In this example, the reflected signals propagate and combine into a second received signal 201. This second received signal will incorporate data based on the second reflected target object signal 211 that appears substantially similar to the data from the original signal of interest. It will also incorporate data based on the second reflected normal clutter signal 221, which is greatly reduced in its level of challenge and obfuscation of the data of interest. It further incorporates data based on the second reflected angled clutter signal 231, which is increased in effective challenge for the radar system. It finally incorporates data based on the second reflected similar clutter signal 241, which is slightly decreased in effective challenge relative to the original data set.

FIG. 3 illustrates a third position for the radar antennas, showing a translated transmit antenna 12 and a translated receive antenna 22 that are in a further relative position with respect to the target object 1, normal clutter 2, angled clutter 3, and similar clutter 4. In this more exaggerated position, the translated transmit antenna 12 transmits a third transmitted signal 102 towards the objects. Similar to the previous cases, the transmitted signal propagates towards the objects, illuminating the target object 1 with a third incoming target object signal 112 resulting in the third reflected target object signal 212. Again, because of the characteristics of a metallic sphere and the waveform selected, the third reflected target object signal 212 is nearly identical in characteristics to the previous target object signals 210 and 211, except for the directionality of the reflection.

The transmitted signal illuminates the normal clutter 2 with an incoming third normal clutter signal 122, resulting in the third reflected normal clutter signal 222. In this new position, the angle of incidence is further increasing, so the third reflected normal clutter signal 222 is further reduced in magnitude and challenge for the radar system. In this example it can be assumed that in this third position, there is no significant contribution to the overall clutter backscatter signal provided by this object.

In a similar fashion, the transmitted signal illuminates the angled clutter 3 with an incoming third angled clutter signal 132, resulting in the third reflected angled clutter signal 232. In this new position for this example case, the physical angle of reflection is now nearly perpendicular to the incoming signal, so the third reflected angled clutter signal 232 will have substantially increased in magnitude, and is the strongest of the signals reflected, presenting the greatest challenge to the radar system.

As before, the transmitted signal further illuminates the similar clutter 4 with a third incoming similar clutter signal 142, resulting in the third reflected similar clutter signal 232. In this new position, the angle of incidence on the similar clutter 4 is high enough that the ovoid shape of the similar clutter 4 is going to finally present a third reflected similar clutter signal 242 that is notably different from any of the reflected similar clutter signals 230, 231, and 232. The change in reflections finally present a reduced challenge to the radar system.

As before, all of the four reflected signals from the objects propagate back to the translated receive antenna 22 where they decay, shift, and combine to form the third received signal 202. This third received signal will incorporate data based on the second reflected target object signal 212 that appears similar to all previous data from the target object. It will also incorporate data based on the third reflected normal clutter signal 222, which does not present much contribution to the total signal. It further incorporates data based on the third angled clutter signal 232, which is the majority of the total third received signal 202. It finally incorporates data based on the third similar clutter signal 242, which is now different enough from the third target object signal 212 to have a reduced likelihood of a false positive.

The crux of the present subject matter is the manner in which the received signals from spatially diverse data sets are processed. Continuing the example from FIGS. 1-3, we can examine the types of signals that have been received during the three spatially diverse data collection events. The signal we are attempting to identify is low in magnitude, but essentially unchanging during all three events. The signals we are not interested in resolving are the cluttering objects, which are individually high in magnitude at any one or multiple times, but are not always high across all frequencies of interest across all data collection events. It is precisely these critical characteristics that the present subject matter exploits in order to resolve the signal of interest.

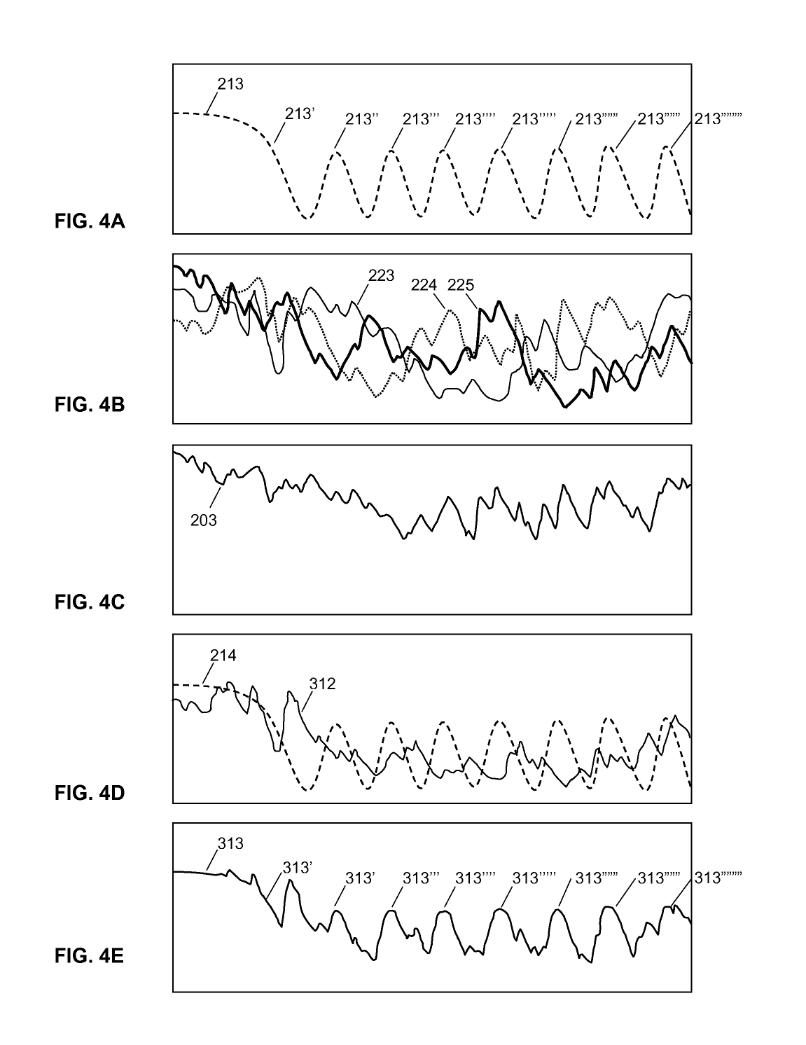

FIG. 4A illustrates the signal we are attempting to resolve, which is the characteristic signal associated with the target object 1 as received during any one of the data collection events, shown as a unitless magnitude (vertical axis) as a function of frequency (horizontal axis). The signal illustrated is not the characteristic of a perfect sphere, but is instead representative of the signal characteristics of a weapon firearm, to be used as an example due to the complexity and interest. The barrel of a typical firearm, for example, is essentially a hollow tube of metal, open on one end and closed on the other where the round, chamber, and firing mechanism is configured. Such an object may appear to one skilled in the art of RF engineering to be similar to a circular waveguide, a type of transmission line. Under the right conditions including, but not limited to, an appropriate frequency, power level, aim, range, and directivity, some of the electromagnetic energy from the transmitted radar signal will enter the mouth of the firearm barrel and propagate.

Circular waveguides are capable of propagating various modes of energy transmission, including the well-behaved, low-loss mode TE₁₁. RF signals of frequencies lower than the TE₁₁ cutoff frequency will not launch into the waveguide any appreciable distance, which is seen in FIG. 4A as the low-frequency region of the target characteristic signal 213. As the cutoff frequency is reached, electromagnetic energy is able to couple into the waveguide, which is identifiable as target launch characteristic 213′. As the wave propagates down the barrel to the end, it will reflect off of a short, creating a resonance for specific frequencies based on barrel length. The first resonant characteristic 213″ can be identified in the signal response from broadband radar. Other resonances follow, including but not limited to a second resonant characteristic 213′″, a third resonant characteristic 213″, a fourth resonant characteristic 213″, a fifth resonant characteristic 213′, a sixth resonant characteristic 213′, a seventh resonant characteristic 213′, etc. up to the limit of propagation and launch characteristics of the waveguide.

Further quantifying the example, the TE₁₁ cutoff frequencies can be calculated for a typical AK-47 rifle barrel. For an air-filled metallic waveguide that is 7.62 mm in diameter, the TE₁₁ mode cutoff frequency is 23.1 GHz, above which the barrel will tend to act as a waveguide. Resonances then occur every 350 MHz or so, with steps varying by frequency from waveguide launch, and as based on the exact make, model, and accessories of the weapon and its ammunition which defines its effective barrel length as a function of frequency.

In some implementations, a library of radio frequency signatures can be empirically derived or electromagnetically modeled for a plurality of objects of interest (e.g., firearms, vessels, buoys, etc.) so that received radio frequency signals can be compared to objects characterized in the library in order to determine whether the objects are present in a particular zone. The library can also include data characterizing directionality of the objects (i.e., whether an object is pointed at or abeam to a particular location). The received radio frequency signals can be modified, harmonized, and/or analyzed to reflect factors that can be relevant to identification, such as distance.

In some implementations, radio frequency patterns of objects of interest can be used to recognize the presence of a type of object, though not necessarily an exact definition of an object. Firearm weapon barrels, for example, will exhibit identifiable features, such as waveguide resonance and polarization differences, which can signify the presence of a threatening firearm which might not be present in a library of characterized firearms and variants. Similarly, many characteristics of different types of boats are common to most members of each type, such as masts, sails, railings, crossbeams, waterline structures, etc. These characteristics can be identified in type of electromagnetic response, so that a type can be identified (e.g., sportfishing boat) even if a specific craft may not be present in a limited library. This is analogous to the way in which face-recognition software can identify the presence of a face in an image due to common patterns (e.g., two eyes, a nose, mouth, chin, and hair), although it may not identify which person the face belongs to.

FIG. 4B illustrates three fabricated example sets of received data showing unitless magnitude with respect to frequency. The first received clutter signal 223 represents a set of data that would be received if only the cluttering objects (and no target object) were present under the first position illustrated by FIG. 1. The second received clutter signal 224 represents a set of data that would be received if only the cluttering objects were present under the second position illustrated by FIG. 2. Similarly, the third received clutter signal 225 represents a set of data that would be received if only the cluttering objects were present under the third position illustrated by FIG. 3. It is implied (as may often be true in reality) that the magnitude of the clutter contributions to received signal at each instant in time and position is often much higher than the signal presented by the target of interest in the frequency band of interest.

The crux of the target resolution problem is illustrated in FIG. 4C, which illustrates a typical example of a data set that integrates all of the signals from FIGS. 4A and 4B. This mathematical action is precisely what typical radar systems perform on sets of received data, and it is seen that the target signal of interest cannot be resolved through the much higher reflections provided by the cluttering objects. This hypothetical example is a greatly simplified version of exactly what occurs in presently fielded radar systems interrogating regions of substantial clutter.

FIG. 4D illustrates a method to reduce the effects of moving clutter instead of compound effects through integration. The signal of interest is the target object, and if the minimum signal level associated only with the reflections from the target object over each of the three positions is examined, one would see the additive target contribution signal 214 that is very similar to the original target characteristic signal 213. The contributions to the returned signal for each position are nearly identical in magnitude, so this is as expected. An entirely different result is obtained when examining the contributions from the cluttering object reflections. If each of the first received clutter signal 223, the second received clutter signal 224, and the third received clutter signal 225 are compared and weighted separately for each frequency point, a processed combination of clutter contributions results. In the example contribution data provided by processed clutter contribution 312, the weighting factor for the lowest magnitude value at each frequency point is set to “one”, and the weighting factors for the middle and highest magnitude values at each frequency point is set to “zero”. The three data sets are then added together after weighting to obtain the processed clutter contribution 312, representing the lowest values of clutter contribution for each physical location of the radar antennas.

The actual effects of such weighting and adding is seen in FIG. 4E, which illustrates the processed data signal 313 that would result. The processed data signal 313 demonstrates many of the characteristics associated with the reflections from the target object 1 as well as the various cluttering objects from each of the three data collection events. The processed target launch characteristic 313′ is not as evident as the detection goal of the target launch characteristic 213′, as it is still largely concealed by the clutter effects. Similarly, the processed first resonant characteristic 313″ is seen to have clutter partially concealing the original first resonant characteristic 213″. In the upper frequencies of the regions, however, the clutter data changed values in a more substantial manner, allowing the weighting and adding to result in dramatic suppression of the effects of clutter. The processed second resonant characteristic 313′″ is a clear peak, similar to the original second resonant characteristic 213′″, although clutter remains in the frequency of this peak. Other resonances such as the processed third resonant characteristic 313″″, processed fourth resonant characteristic 313′″″, processed fifth resonant characteristic 313″″″, and processed sixth resonant characteristic 213′″″″ are readily resolvable and comparable to the original resonant characteristics of the target object. It is not until the processed seventh resonant characteristic 313″″″″, that the clutter appears at the same magnitude and conceals the signal of interest again.

The end result of FIG. 4E is that a series of resonant peaks have been resolved because the reflected signal response of the target object did not vary, while that of the cluttering objects varied greatly throughout a particular frequency band wide. The remainder of the signal processing methods present in the radar system can then easily identify the presence of the target object 1 in the processed target launch characteristic 313. The location of the target object can then be correlated to the field of view associated with the three data sets used to obtain this processed data, and the user can be alerted.

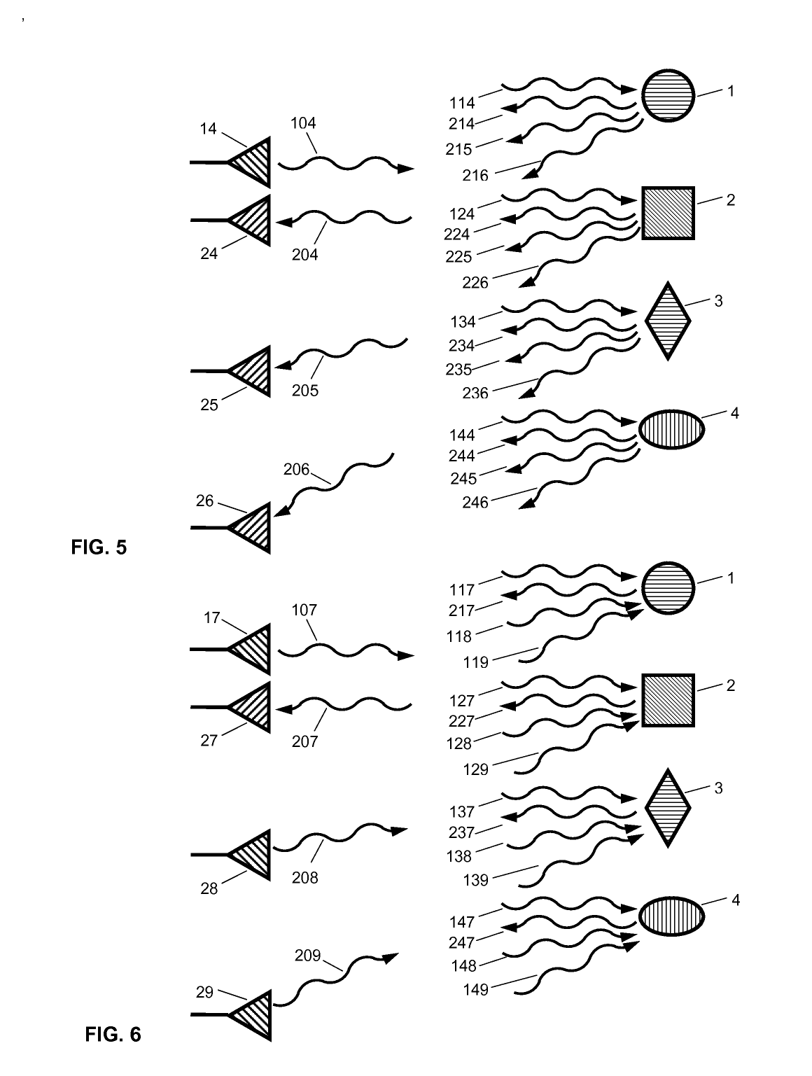

In the architecture illustrated in FIGS. 1-3, the radar system comprised a single transmit antenna 10 and a single receive antenna 20. The spatial diversity was provided by a means of relocating the antennas to new positions 11, 21, 12, and 22. Many architectural variations are envisioned as being appropriate for radar systems employing the current subject matter. An important variant is to employ multiple transmit antennas and/or multiple receive antennas, with examples illustrated in FIGS. 5 and 6. Adding multiple transmit and/or receive antennas enables multiple data sets of reflections to be obtained from different locations simultaneously, as opposed to having to move a single antenna or set of antennas in order to obtain spatial diversity.

In FIG. 5, the radar architecture comprises a single transmit antenna 14 of a multiple-receive radar system, from which a single transmitted signal 104 illuminates four objects as previously described. After propagation, the single transmitted signal 104 results in a single incoming target object signal 114 illuminating target object 1. Three reflections result, the first being a first reflected target object signal 214 directed towards a first receive antenna 24. In addition, there is a second reflected target object signal 215 directed towards a second receive antenna 25, and a third reflected target object signal 216 directed towards a third receive antenna 26.

After propagation, the single transmitted signal 104 also illuminates normal clutter 2, with a single incoming normal clutter signal 124. In a similar manner as with the target object 1, three reflections result, the first being a first reflected normal clutter 224 directed towards a first receive antenna 24, a second reflected normal clutter signal 225 directed towards a second receive antenna 25, and a third reflected normal clutter signal 226 directed towards a third receive antenna 26.

The single transmitted signal 104 further illuminates angled clutter 3, with a single incoming angled clutter signal 134. As expected, three reflections result, the first being a first reflected angled clutter 234 directed towards a first receive antenna 24, a second reflected angled clutter signal 235 directed towards a second receive antenna 25, and a third reflected angled clutter signal 236 directed towards a third receive antenna 26.

The single transmitted signal 104 further illuminates similar clutter 4, with a single incoming similar clutter signal 144. As expected, three reflections result, the first being a first reflected similar clutter 244 directed towards a first receive antenna 24, a second reflected similar clutter signal 245 directed towards a second receive antenna 25, and a third reflected similar clutter signal 246 directed towards a third receive antenna 26.

The spatial diversity of this architecture is evident in the manner in which the signals reflected and transformed from the target and clutter objects are combined at the three receive antennas. The four signals reflected from the objects back towards the first receive antenna 24 through propagation decay and other effects previously discussed. As combined and transformed, these signals comprise a first combined signal 204. Similarly, the four signals reflected from the objects back towards the second receive antenna 25 are combined and transformed into a second combined signal 205. Further, the four signals reflected from the objects back towards the third receive antenna 26 are combined and transformed into a third combined signal 206.

The first combined signal 204, second combined signal 205, and third combined signal 206 can now be comparing and processed data point by data point for each frequency. As these signals were all received at the same time by three different antennas, the spatial diversity is obtained without any time delay, and signal processing can begin immediately upon receipt of the three combined signals. The slightly different path delay, loss, and phase difference need to be accounted for in transit time and signal transformation en route to the furthest antenna, implied in the example of FIG. 5 to be the third receive antenna 26.

In some implementations according the present subject matter, weighting of the data points for multiple signals with different path lengths may follow a much more complex selection process and calculation than the simple “zero or one” used in the initial example of FIGS. 4A-4E. A first modification would be to adjust the weight values based on the known calculable path decay associated with the different path length from the objects to the first receive antenna 24 as compared to the longer path length to the second receive antenna 25 and third receive antenna 26. The process for identifying appropriate weighting functions for data points associated with different received signals are left to those skilled in the art, and the many variations that can possibly be used for different types of targets, clutter, and physical arrangements are beyond the scope of discussion.

In FIG. 6, the radar architecture comprises a single receive antenna 27 of a multiple-transmit radar system, from which three signals illuminate four objects as previously described. After propagation, a first transmitted signal 107 results in a first incoming target object signal 117 illuminating target object 1. In addition, a second transmitted signal 208 results in a second incoming target object signal 118, and a third transmitted signal 209 results in a third incoming target object signal 119. These three incoming target object signals superimpose and result in a single reflected target object signal 217 directed towards the single receive antenna 27. The nature of the transmit signals is such that each contains different characteristics, including but not limited to different frequencies, polarizations, phase delays, data encoding, pulse characteristics, and time-varying aspects such as “chirping” characteristics. As such, the resulting single reflected target object signal 217 may contain signal characteristics that are discernable as originating or resulting from differences in the three transmitted signals. When different characteristics are resolvable, this provides a means for separating the reflection data associated with each of the spatially diverse transmit signals.

Completing the description of FIG. 6 is a matter of repetition in a similar manner as the description of the example system architecture illustrated FIG. 5. After propagation, the first transmitted signal 107 also illuminates normal clutter 2 with a first incoming normal clutter signal 127. In a similar manner as with the target object 1, a second transmitted signal 208 results in a second incoming normal clutter signal 128, and a third transmitted signal 209 results in a third incoming normal clutter signal 129. These three incoming normal clutter signals superimpose and result in a single reflected normal clutter signal 227 directed towards the single receive antenna 27.

The first transmitted signal 107 also illuminates angled clutter 3 with a first incoming angled clutter signal 137. In a similar manner as with the target object 1, a second transmitted signal 208 results in a second incoming angled clutter signal 138, and a third transmitted signal 209 results in a third incoming angled clutter signal 139. These three incoming angled clutter signals superimpose and result in a single reflected angled clutter signal 237 directed towards the single receive antenna 27.

The first transmitted signal 107 further illuminates similar clutter 4 with a first incoming similar clutter signal 147. As expected, a second transmitted signal 208 results in a second incoming similar clutter signal 148, and a third transmitted signal 209 results in a third incoming similar clutter signal 149. These three incoming similar clutter signals superimpose and result in a single reflected similar clutter signal 247 directed towards the single receive antenna 27.

The spatial diversity of this architecture is evident in the manner in which the three transmitted signals were differentiated prior to or during transmission. Effectively, the combining of the signals was performed by the target and cluttering objects, with the single receive antenna receiving a single reflected clutter signal 207 signals that incorporates all of the data from each reflection. Downstream receiver electronics (not shown) would then be responsible for demodulating the data associated with the three transmissions. In some implementations of the present subject matter, part or all of this demodulation could be performed in hardware components. In some implementations of the present subject matter, part or all of this separation process could be performed in software. Once separated, the three data sets can then be analyzed using the weighting and combining signal processes of the present subject matter previously described, along with target identification signal processes known to those skilled in the art.

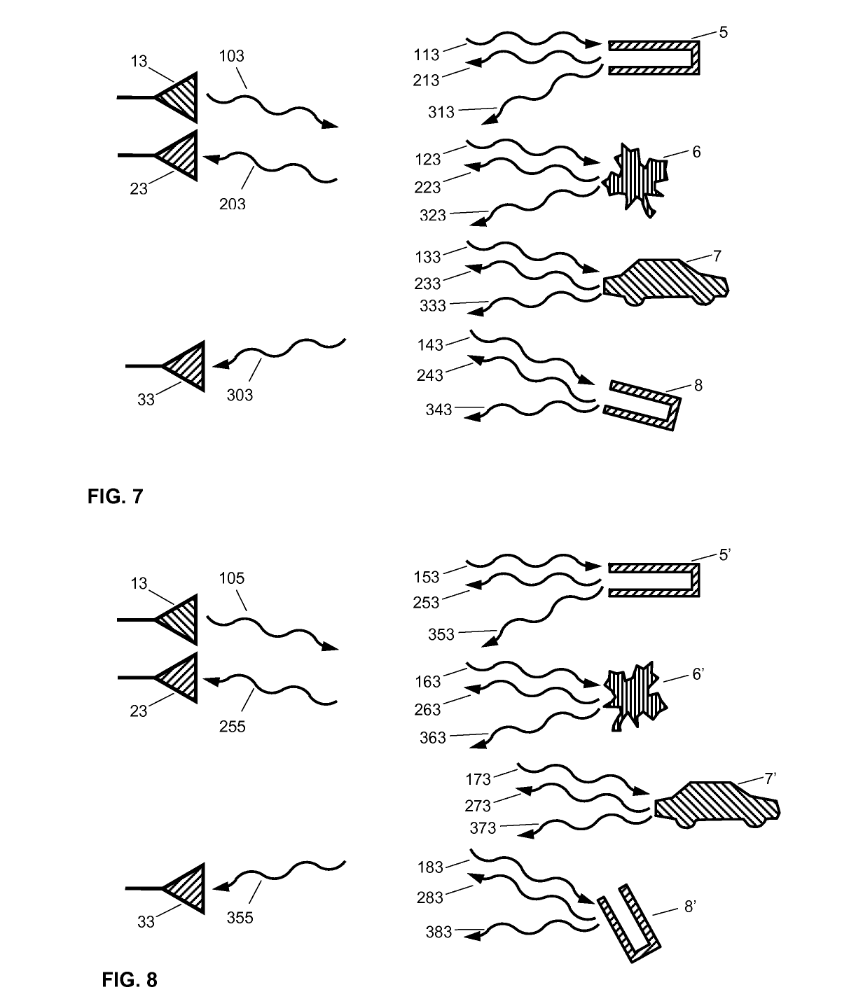

The example radar system architecture illustrated by FIG. 7 and FIG. 8 is a system comprised of a transmitting antenna subsystem 13, a first receiving antenna subsystem 23, and a second receiving antenna subsystem 33. Some element of special diversity is intrinsic to the separation of the two receive antennas in a similar manner as the system architecture illustrated in FIG. 5. In this example, the radar system is part of a weapon threat sensor attempting to locate the presence of an initial threatening firearm 5 in the field of view. Also in the field of view are three cluttering objects, including initial foliage 6, initial vehicle 7, and initial weapon clutter 8, which is intended to represent a non-threatening firearm from a civilian or ally who is moving his weapon's aim away from the direction of the radar system.

In FIG. 5, a primary transmission 103 is emitted from the transmitting antenna subsystem 13, propagating through the environment to illuminate an initial threatening firearm 5 with an incident initial threatening firearm signal 113. The signal is reflected and transformed into a first initial threatening firearm reflection 213 that propagates towards the first receiving antenna subsystem 23 and a second initial threatening firearm reflection 313 that propagates towards the second receiving antenna subsystem 33.

The primary transmission 103 also illuminates initial foliage 6 with an incident initial foliage signal 123. The signal is reflected and transformed into a first initial foliage reflection 223 that propagates towards the first receiving antenna subsystem 23 and a second initial foliage reflection 323 that propagates towards the second receiving antenna subsystem 33. In a similar manner, the primary transmission 103 also illuminates the initial vehicle 7 with an incident initial vehicle signal 133. This signal is reflected and transformed into a first initial vehicle reflection 233 directed towards the first receiving antenna subsystem 23 and a second initial vehicle reflection 333 directed towards the second receiving antenna subsystem 33. The primary transmission 103 further illuminates the initial non-threatening firearm 8 with an incident initial non-threat signal 143. This signal is reflected and transformed into a first initial non-threat reflection 243 directed towards the first receiving antenna subsystem 23 and a second initial non-threat reflection 343 directed towards the second receiving antenna subsystem 33.

The four first reflected signals 213, 223, 233, and 243 propagate towards the first receiving antenna subsystem 23, and are combined and received as a first received data signal 203. Similarly, the four second reflected signals 313, 323, 333, and 343 propagate towards the second receiving antenna subsystem 33, and are combined and received as a second received data signal 303. Without further progressing through time and/or space, spatial diversity has already been realized in this example scenario, and a first signal processing method is able to begin to suppress clutter between the two combined received signals.

The scenario continues with FIG. 8, which represents a point in time after that illustrated in FIG. 7. In FIG. 8, the unmoving threatening firearm 5′ has maintained its position as it continues to aim at or near the radar system. While the firearm threat has not substantially moved or changed electromagnetic characteristics during this period of time, other objects have moved. The foliage, for example, is now represented in FIG. 8 as rustled foliage 6′, illustrated in this example as a small rotation of the leaf shape. In reality, wind-driven foliage or other moving features can translate, rotate, and otherwise move directions in both predictable and unpredictable manners, so the exact position change is meant only to be instructive by example. Other objects also move, such as the moved vehicle 7′ and the rotated non-threatening firearm 8′. As an implementation of the present subject matter, this example demonstrates the case of incorporating both engineered spatial diversity with two receive antennas and time-varying spatial diversity with moving clutter features. It is envisioned that in further implementations of the present subject matter, additional spatial diversity could be accomplished by moving the radar system antennas as well, perhaps as part of a vehicle-mounted system, so three different aspects of spatial diversity could be incorporated into a single scenario quite readily.

The remainder of the description of FIG. 8 follows the same format as previous figures and examples. A later transmission 105 is emitted from the transmitting antenna subsystem 13, propagating through the environment to illuminate a later threatening firearm 5′ with an incident later threatening firearm signal 153. The signal is reflected and transformed into a first later threatening firearm reflection 253 that propagates towards the first receiving antenna subsystem 23 and a second later threatening firearm reflection 353 that propagates towards the second receiving antenna subsystem 33.

The later transmission 105 also illuminates rustled foliage 6′ with an incident later foliage signal 163. The signal is reflected and transformed into a first later foliage reflection 263 that propagates towards the first receiving antenna subsystem 23 and a second later foliage reflection 363 that propagates towards the second receiving antenna subsystem 33. The later transmission 105 also illuminates the moved vehicle 7′ with an incident later vehicle signal 173. This signal is reflected and transformed into a first later vehicle reflection 273 directed towards the first receiving antenna subsystem 23 and a second later vehicle reflection 373 directed towards the second receiving antenna subsystem 33. The later transmission 105 lastly illuminates the rotated non-threatening firearm 8′ with an incident later non-threat signal 183. This signal is reflected and transformed into a first later non-threat reflection 283 directed towards the first receiving antenna subsystem 23 and a second later non-threat reflection 383 directed towards the second receiving antenna subsystem 33.

The four reflected signals 253, 263, 273, and 283 propagate towards the first receiving antenna subsystem 23, and are combined and received as a first delayed data signal 255. Similarly, the four reflected signals 353, 363, 373, and 383 propagate towards the second receiving antenna subsystem 33, and are combined and received as a second delayed data signal 355. The combined data signals generated from the initial and later transmission events as received by the first and second receive antenna subsystems provide four different data sets that vary in location and characteristics of object movement, providing a matrix of data with multiple types of spatial diversity.

In certain implementations of the present subject matter, advanced weighting algorithms may determine that one type of data set may provide more or less reliable data with respect to clutter suppression and target resolution. A different weighting algorithm may be used between different data sets, times, frequency bands, or other characteristics. For example, data sets obtained from zones of interest that are at a comparatively long range with respect to the transmitted power, receiver sensitivity, and noise budget may be integrated before other weighting functions are performed. Similarly, transmit signals with rapidly varying frequencies may result in data sets that may benefit from convolution prior to the application of other weighting functions. Furthermore, specific subsets of data sets may require adding or subtracting with other subsets of data sets to mitigate the effects of specific types of cluttering objects with heightened characteristics in specific frequency bands and/or polarizations.

In each case, the purpose of advanced, partial, or layered weighting schemes is to improve the ability to identify a target of interest. In the case of a sniper detection sensor, for example, the weighting of data sets to create an improved radar signature enables the specific radar characteristics of firearm barrels to be more easily identified. When a positive match corresponding to a specific firearm barrel size (aimed at or near the antenna) is identified and validated as being a likely threat, the user can be alerted, and the user can also be provided a description of the specific firearm detected as well as its location, all extracted from the received signals.

A conducting length of one or more elements of a weapon, platform, vehicle, accessory, or other target can serve as an antenna, which will radiate or re-radiate specific frequencies of RF signals in a manner that can be detected in an improved manner in the context of this subject matter. Re-radiation of the transmitted radar signal provides for a return signal characteristic that will not vary in the same manner as surrounding clutter, enabling spatial and/or temporal weighting and integration to suppress said clutter. When used in conjunction with waveguide detection methods, such detectable RF characteristic can provide validation of the presence of metal objects likely to be threats or other targets of interest in the interrogated volume.

A radar system employing the current subject matter can operate in a frequency range of interest for identifying the backscatter characteristics of targets that include waveguide reflection characteristics from a weapon barrel, or resonant characteristics of one or more elements of a weapon, platform, vehicle, accessory, or other target of interest. The radar antenna generally has a sufficiently high gain to give the system a useable range, and a sufficiently narrow beam width to provide the user with a meaningful location of potential targets. Fortunately, these requirements are complementary, so that the size and range of the system is limited primarily by the power, cost, and size budget of the intended platform (ground or air vehicle, fixed platform, man-portable, etc.).

The subject matter described herein may be embodied in systems, apparatus, methods, and/or articles depending on the desired configuration. In particular, aspects of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., trackball, mouse, touch screen, etc.), and at least one output device.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flows described herein do not require the particular order shown, or sequential order, to achieve desirable results. Other embodiments may be within the scope of one or more claims.

What is claimed is:

1. A method comprising:
receiving data characterizing a plurality of sets of data collected within a zone of interest, by at least one receiver of a radar system, each data set comprising a collection of phase and amplitude values for a range of frequencies, at least two of the data sets being spatially and/or temporally diverse, the zone of interest comprising at least one clutter object;
weighting each of the sets of data according to weighting parameters, the weighting parameters being configured to selectively reduce effects of clutter within the zone of interest associated with the at least one clutter object;
combining the weighted data sets to result in an enhanced radar signature; and
providing data characterizing the enhanced radar signature.

2. A method as in claim 1, wherein the providing data comprises one or more of: transmitting at least a portion of the data characterizing the enhanced radar signature, displaying at least a portion of the data characterizing the enhanced radar signature, loading at least a portion of the data characterizing the enhanced radar signature, storing at least a portion of the data characterizing the enhanced radar signature, initiating at least one visual and/or audio alert based on the enhanced radar signature.

3. A method as in claim 1, wherein the zone of interest comprises at least one target object and the enhanced radar signature contains features readily identifiable of at least one target object.

4. A method as in claim 1, wherein the receiving, weighting, combining, and providing are implemented by at least one data processor forming part of at least one computing system.

5. A method as in claim 1, wherein each weighting parameter is based on at least one parameter selected from a group consisting of: location of the corresponding receiver, location of the corresponding transmitter, time at which the corresponding data set was generated, potential target objects within the zone of interest, known target objects within the zone of interest, potential clutter objects within the zone of interest, known clutter objects within the zone of interest, polarization of the radar signal, location of the clutter objects relative to the location of the corresponding transmitter, and location of the clutter objects relative to the location of the corresponding receiver.

6. A method as in claim 1, wherein the combining of the weighted data sets comprises one or more operation selected from a group consisting of: adding, subtracting, integrating, and convoluting.

7. A method as in claim 1, wherein each of the sets of data is weighted according to weighting parameters for each of a plurality of frequency points.

8. A method as in claim 1, wherein each of the sets of data is weighted according to weighting parameters that are dynamically adjusted based on previously received signals from the zone of interest.

9. A method as in claim 1, wherein the radar system is a wideband radar system.

10. A non-transitory computer program product storing instructions, which when executed by at least one data processor, result in operations comprising:
receiving data characterizing a plurality of sets of data collected within a zone of interest, by at least one receiver of a radar system, each data set comprising a collection of phase and amplitude values for a range of frequencies, at least two of the data sets being spatially and/or temporally diverse, the zone of interest comprising at least one clutter object;
weighting each of the sets of data according to weighting parameters, the weighting parameters being configured to selectively reduce effects of clutter within the zone of interest associated with the at least one clutter object;
combining the weighted data sets to result in an enhanced radar signature; and
providing data characterizing the enhanced radar signature.

11. A system comprising:
one or more radio frequency transmitters;
one or more radio frequency receivers, wherein each is not necessarily co-located with a transmitter;
one or more data processors; and
memory storing instructions, which when executed by at least one data processor of the one or more data processors, result in operations comprising:
receiving data characterizing a plurality of sets of data collected within a zone of interest, by at least one receiver of the radar system, each data set comprising a collection of phase and amplitude values for a range of frequencies, at least two of the data sets being spatially and/or temporally diverse, the zone of interest comprising at least one clutter object;
weighting each of the sets of data according to weighting parameters, the weighting parameters being configured to selectively reduce effects of clutter within the zone of interest associated with the at least one clutter object;
combining the weighted data sets to result in an enhanced radar signature; and
providing data characterizing the enhanced radar signature.

12. A system as in claim 11, wherein the providing data comprises one or more of: transmitting at least a portion of the data characterizing the enhanced radar signature, displaying at least a portion of the data characterizing the enhanced radar signature, loading at least a portion of the data characterizing the enhanced radar signature, storing at least a portion of the data characterizing the enhanced radar signature, initiating at least one visual and/or audio alert based on the enhanced radar signature.

13. A system as in claim 11, wherein the zone of interest comprises at least one target object and the enhanced radar signature identifies at least one target object.

14. A system as in claim 11, wherein each weighting parameter is based on at least one parameter selected from a group consisting of: location of the corresponding transmitter, location of the corresponding receiver, time at which the corresponding data set was generated, potential target objects within the zone of interest, known target objects within the zone of interest, potential clutter objects within the zone of interest, known clutter objects within the zone of interest, polarization of the radar signal, location of the clutter objects relative to the location of the corresponding transmitter, and location of the clutter objects relative to the location of the corresponding receiver.

15. A system as in claim 11, wherein the combining of the weighted data sets comprises one or more operation selected from a group consisting of: adding, subtracting, integrating, and convoluting.

16. A system as in claim 11, wherein each of the sets of data is weighted according to weighting parameters for each of a plurality of frequency points.

17. A system as in claim 11, wherein each of the sets of data is weighted according to weighting parameters that are dynamically adjusted based on previously received signals from the zone of interest.

18. A system as in claim 11, wherein the radar system is a wideband radar system.

19. A system as in claim 11, wherein each set of data comprises at least one reflected signal received by the radar system.

20. A system as in claim 11, wherein the one or more data processors form part of at least one computing system.
